(19) United States
(12) Patent Application Publication
(10) Pub. No.: US 2005/0085615 A1
(43) Pub. Date: Apr. 21, 2005

(54) Solid polyaddition compounds containing uretdione groups

(75) Inventors: Andreas Wenning, Nottuln (DE); Emmanouil Spyrou, Dorsten (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/959,344

(22) Filed: Oct. 7, 2004

(30) Foreign Application Priority Data
Oct. 15, 2003 (DE) 103 47 902.3

(51) Int. Cl. C08G 18/00

(52) U.S. Cl. 528/44

(57) ABSTRACT

Solid polyaddition compounds containing uretdione groups for polyurethane powder coating compositions which can be cured at a low temperature.

### BACKGROUND OF THE INVENTION

1. Field of the Invention

The invention relates to solid polyaddition compounds containing uretdione groups, compositions containing the solid polyaddition compounds, and to a process for preparing such polyaddition compounds.

2. Description of the Related Art

Externally or internally blocked polyisocyanates which are solid at room temperature are useful as crosslinkers for thermally crosslinkable polyurethane (PU) powder coating compositions.

For example, U.S. Pat. No. 4,246,380 describes PU powder coatings featuring outstanding weathering stability and thermal stability. The crosslinkers whose preparation is described in U.S. Pat. No. 4,302,351 are composed of isophorone diisocyanate which contains isocyanurate groups and is blocked with ε-caprolactam. Also known are polyisocyanates which contain urethane, biuret or urea groups and whose isocyanate groups are likewise blocked.

One disadvantage of these externally blocked systems lies in the elimination of the blocking agent during the thermal crosslinking reaction. Since the blocking agent may thus be emitted into the environment, it is necessary on environmental and occupational hygiene grounds to take special measures to clean the outgoing air and/or to recover the blocking agent. Moreover, the reactivity of the crosslinkers is low. Curing temperatures above 170° C. are required.

U.S. Pat. No. 4,463,154 and U.S. Pat. No. 4,483,789 describe processes for preparing polyaddition compounds which contain uretdione groups and whose terminal isocyanate groups are irreversibly blocked with monoalcohols or monoamines. A particular disadvantage are the chain-terminating constituents of the crosslinkers, which lead to low network densities in the PU powder coatings and thus to moderate solvent resistances.

Uretdione powder coating crosslinkers prepared by reacting polyisocyanates containing uretdione groups with diols and with chain extenders containing ester groups and/or carbonate groups, or using dimer diols, are described in U.S. Pat. No. 5,621,064 and in U.S. Pat. No. 5,596,066.

Hydroxyl-terminated polyaddition compounds containing uretdione groups are included in the subject matter of U.S. Pat. No. 6,613,861. On the basis of their functionality of two they exhibit improved resistance to solvents.

A common feature of powder coating compositions based on these polyisocyanates containing uretdione groups is that they do not emit any volatile compounds in the course of the curing reaction. However, the at least 180° C. baking temperatures are high.

The use of amidines as catalysts in PU coating powder compositions is described in U.S. Pat. No. 5,847,044. Although these catalysts lead to a reduction in the curing temperature, they exhibit a considerable yellowing, which is generally unwanted in the coatings field. The cause of this yellowing may be the reactive nitrogen atoms in the amidines. These atoms can react with atmospheric oxygen to give N oxides, which are responsible for the discoloration.

U.S. Pat. No. 5,847,044 also mentions other catalysts which have been used to date for this purpose, but without showing any particular effect on the curing temperature. They include organometallic catalysts known from polyurethane chemistry, such as dibutyltin dilaurate (DBTL), and tertiary amines, such as 1,4 diazabicyclo[2.2.2]octane (DABCO), for example.

WO 00/34355 claims catalysts based on metal acetylacetonates, an example being zinc acetylacetonate. Such catalysts are in fact able to lower the curing temperature of polyurethane powder coating compositions containing uretdione groups, but give primarily allophanates as reaction products (M. Gedan-Smolka, F. Lehmann, D. Lehmann, “New catalysts for the low temperature curing of uretdione powder coatings” International Waterborne, High solids and Powder Coatings Symposium, New Orleans, Feb. 21-23, 2001). Allophanates are the reaction products of one mole of alcohol and two moles of isocyanate, whereas in conventional urethane chemistry one mole of alcohol reacts with one mole of isocyanate. As a result of the unwanted formation of allophanates, therefore, isocyanate groups valuable both technically and economically are destroyed.

DE 103 20 267, U.S. 2003/0153713 and DE 103 20 266 describe metal hydroxides, metal alkoxides, quaternary ammonium salts with hydroxides, fluorides or carboxylates which accelerate the unblocking of uretdione groups so vigorously that when powder coating hardeners containing uretdione groups are used it is possible to achieve a considerable reduction in the curing temperature of powder coating compositions.

A problem coming to all coatings produced from such highly accelerated powder coating compositions is that their surfaces exhibit severe orange peel effects or even exhibit structures.

### SUMMARY OF THE INVENTION

Accordingly, it is an object of the present invention to find new crosslinkers containing uretdione groups, which can be employed in highly reactive polyurethane powder coating compositions whose powder coatings, cured at very low temperatures and being of high gloss or matt and being light and weather-stable, exhibit good leveling.

Surprisingly it has been found that polyaddition compounds containing uretdione groups and incorporating dodecane-1,12-diol as diol component can be used as a crosslinker component for polyurethane powder coating materials which can be cured at very low baking temperatures and whose films exhibit good leveling.

### DETAILED DESCRIPTION OF THE INVENTION

Accordingly, in one aspect of the present invention solid polyaddition compounds containing uretdione groups may be obtained by reacting:
A) from 40% to 90% by mass of at least one aliphatic, (cyclo)aliphatic or cycloaliphatic polyisocyanate component composed of
   1. at least 40% by mass of a polyisocyanate compound containing uretdione groups and having an average functionality of at least 2.0, and
   2. not more than 60% by mass of at least one diisocyanate compound and/or isocyanurate compound without uretdione groups;
B) from 60% to 10% by mass of dodecane-1,12-diol; and
C) from 50% to 0% by mass of at least one further compound having at least one hydroxyl group; where the polyaddition compounds have a melting point of from 40 to 130° C., a free NCO content of less than 5% by weight, and a uretdione content of from 6 to 18% by weight.

The invention further provides a process for preparing solid polyaddition compounds containing uretdione groups.

The polyisocyanates A1) containing uretdione groups that may be used in accordance with one embodiment of the invention may be obtained from any desired diisocyanates by catalytic dimerization of the isocyanate groups. The desired diisocyanates for preparing the starting compounds A1) may be aliphatic, cycloaliphatic, araliphatic and/or aromatic diisocyanates. Preferred examples include 1,6-diisocyanatohexane (HDI), 2-methylpentamethylene 1,5-diisocyanate (DI 51), 2,2,4-(2,4,4)-trimethylhexamethylene diisocyanate, 4,4′-diisocyanatodicyclohexyl-methane, 1,3- and 1,4-diisocyanatocyclohexane, isophorone diisocyanate (IPDI), diphenylmethane 2,4′- and/or 4,4′-diisocyanate, xylylene diisocyanate or 2,4- and 2,6-tolylene diisocyanate, and any desired mixtures of these isomers, it being possible for these diisocyanates to be used alone or in mixtures to prepare component A1). The polyisocyanates containing uretdione groups can be also be mixed arbitrarily with one another.

Suitable catalysts for preparing the starting compounds A1) from the aforementioned diisocyanates include in principle all known compounds which catalyze the dimerization of isocyanate groups. Examples include tertiary organic phosphines (U.S. A 4 614 785, DE-A 19 34 763, and U.S. Pat. No. 4,994,541), tris(dialkylamino)phosphines (U.S. Pat. No. 4,476,054, U.S. Pat. No. 4,668,780, and U.S. Pat. No. 4,929,724), substituted pyridines (DE-A 10 81 895 and U.S. Pat. No. 4,912,210), and substituted imidazoles or benzimidazoles (U.S. Pat. No. 5,329,003), each of which is incorporated herein by reference in its entirety.

Preferred starting compounds A1) for the process of the invention include polyisocyanates containing uretdione groups that have been prepared from diisocyanates containing aliphatically and/or cycloaliphatically attached isocyanate groups.

Particular preference is given to using the uretdiones of isophorone diisocyanate (IPDI) and of 1,6-diisocyanatohexane (HDI).

The isocyanurate-free uretdione of isophorone diisocyanate may be of high viscosity at room temperature, for example more than 106 mPa·s; at 60° C. the viscosity may be 13×10³ mPa·s and at 80° C. it may be 1.4×10³ mPa s. The free NCO content may be from 16.8% to 18.5% by mass, meaning that there may be more or less high fractions of IPDI polyuretdione in the reaction product. The monomer content may be 1% by mass. The total NCO content of the reaction product after heating at from 180 to 200° C. may be from 37.5% to 37.8% by weight.

In the course of the dimerization of aliphatic diisocyanates by conventional processes and with conventional catalysts, an isocyanurate byproduct may be formed in different amounts, so that the NCO functionality of the isocyanurate-containing polyisocyanate uretdiones employed is at least 2.

The diisocyanates A2) may include the diisocyanates indicated above that are suitable for preparing component A1). They may account for up to 60% by weight of the total of starting compounds A1) and A2). Examples of suitable mixtures also include solutions of uretdiones in diisocyanates, such as are obtained following catalytic dimerization where the unreacted diisocyanate is not separated off. Included with preference are IPDI and/or HDI.

The isocyanurates A2) may preferably be the trimers of the diisocyanates also used to prepare the polyisocyanate compounds A1) containing uretdione groups. The isocyanurates can be added separately to the polyisocyanate compound A1) or else are already a part of the polyisocyanate compound A1), since in some cases they are formed during the dimerization of diisocyanates as a byproduct. As starting compounds A2) it is preferred to use IPDI and/or HDI.

Suitable compounds C) include all monools, diols or polyols which are commonly employed in PU chemistry and whose molecular weight is at least 32.

Examples of the monoalcohols include methanol, ethanol, n-propanol, isopropanol, n-butanol, isobutanol, sec-butanol, the isomeric pentanols, hexanols, octanols, nonanols, n-decanol, n-dodecanol, n-tetradecanol, n-hexadecanol, n-octadecanol, cyclohexanol, the isomeric methylcyclohexanols, and hydroxymethylcyclohexane and mixtures thereof.

In the case of the diols examples include ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol, and neopentyl glycol hydroxypivalate and mixtures thereof.

In the case of the triols examples include trimethylolpropane, ditrimethylolpropane, trimethylolethane, hexane-1,2,6-triol, butane-1,2,4-triol, tris(β-hydroxyethyl)isocyanurate, pentaerythritol, mannitol, and sorbitol and mixtures thereof.

Also suitable are diols or polyols containing further functional groups. These are the conventional hydroxyl-containing polyesters, polycarbonates, polycaprolactones, polyethers, polythioethers, polyesteramides, polyurethanes or polyacetals and mixtures thereof. They possess a number-average molecular weight of from 134 to 3500.

The monools, diols or polyols may be used alone or in mixtures.

The uretdione group-containing polyaddition products of one embodiment of the invention may be obtained in accordance with the process described as follows:

In another aspect of the invention, the solid polyaddition compounds containing uretdione groups may be prepared by reacting
A) from 40% to 90% by mass of at least one aliphatic, (cyclo)aliphatic or cycloaliphatic polyisocyanate component composed of
   1. at least 40% by mass of a polyisocyanate compound containing uretdione groups and having an average functionality of at least 2.0 and
   2. not more than 60% by mass of at least one diisocyanate compound and/or isocyanurate compound without uretdione groups;
B) from 60% to 10% by mass of dodecane-1,12-diol; and
C) from 50% to 0% by mass of at least one further compound having at least one hydroxyl group; wherein the polyaddition compounds have a melting point of from 40 to 130° C., a free NCO content of less than 5% by weight, and a uretdione content of from 6 to 18% by weight, where the reaction is carried out in a solvent at from 50 to 100° C. or without solvent in an intensive kneading apparatus at from 110 to 190° C.

The reaction in solvent may take place at temperatures of from 50 to 100° C., preferably between 60 and 90° C. The hydroxyl-bearing components B) and, where appropriate, C) may be introduced to a reaction vessel or reaction mixture initially and the polyaddition compound A) containing uretdione groups may be added as rapidly as possible without the reaction temperature exceeding the limits specified above. The starting compounds B) and C) may be alternatively be introduced together or reacted in any order, individually or in a mixture, in succession, with the polyaddition compound A) containing uretdione groups. When reaction has taken place, the solvent may be removed. Suitable for that purpose are evaporation screws, film extruders or else spray driers.

Suitable solvents include, for example, benzene, toluene or other aromatic and/or aliphatic hydrocarbons, acetic esters, such as ethyl acetate or butyl acetate, and ketones, such as acetone, methyl ethyl ketone, and methyl isobutyl ketone, or chlorinated aromatic and aliphatic hydrocarbons, and also any desired mixtures of these or other inert solvents.

In an embodiment, the invention further provides the solvent-free, continuous preparation of the polyaddition products of the invention containing uretdione groups by means of intensive kneading apparatus, such as in a single-screw or multi-screw extruder, in particular in a twin-screw extruder, planetary roll extruder or annular extruder. The solvent-free synthesis requires temperatures of 110 to 190° C., which are already well within the unblocking range for uretdione groups. The short reaction times of <5 minutes, preferably <3 minutes, in particular <2 minutes have proven advantageous here. The brief thermal exposure is enough to provide homogeneous mixing of the reactants with substantial or complete reaction. Thereafter, controlled cooling is carried out in accordance with the setting of an equilibrium and, if necessary, the conversion is completed.

The reaction products may be supplied to the reaction/kneading apparatus in separate product streams, it being possible for the starting components and/or product streams to be preheated to up to 120° C., preferably to 90° C. Where there are more than two product streams they may also be metered in bundled form. Starting compounds B) and/or C) and/or catalysts and/or further customary coatings adjuvants, such as leveling agents and/or stabilizers, can be assembled into one or more product streams.

It is likewise possible to vary the sequence of the product streams and for the entry point of the product streams to be different.

Subsequent reaction, cooling, comminuting, and bagging may be performed using known techniques and technologies.

In order to accelerate the polyaddition reaction it is also possible to use catalysts customary in PU chemistry. They may be employed in a concentration of from 0.01% to 2% by weight, preferably from 0.03% to 0.5% by weight, based on the reaction components used. Examples of catalysts include tertiary amines, such as triethylamine, pyridine or N,N-dimethylaminocyclohexane, or metal salts, such as iron(III) chloride, molybdenum glycolate, and zinc chloride. Tin(II) and tin(IV) compounds have proven especially suitable. Particular mention may be made here of dibutyltin dilaurate (DBTL) and tin octoate.

The subject matter of the invention is illustrated below with reference to examples which are not intended to further limit the invention.

### EXAMPLES

A) Preparation of the Polyaddition Compound Containing Uretdione Groups

1. From Solvent

In a reactor, 230 g of dodecane-1,12-diol and 0.5 g of dibutyltin dilaurate were dissolved in 111 of acetone. The solution was heated to 50° C. With vigorous stirring and under an inert gas atmosphere 470 g of IPDI uretdione were added. The reaction was monitored by titrimetric determination of NCO and was over after 2 hours. At that point the solvent was removed and the product was cooled and comminuted. It had a melting range of 89 to 92° C. and an NCO content of 11.4%.

2. Solventlessly

470 g of IPDI uretdione were fed at a temperature of 60 to 110° C. into the intake barrel section of a twin-screw extruder at the same time as a mixture of 230 g of dodecane-1,12-diol and 0.5 g of dibutyltin dilaurate was metered in with a temperature of 25 to 110° C.

The extruder employed was made up of ten barrel sections, of which five were heating zones. The set point temperatures of the five heating zones are situated between 50 and 180° C. and can be controlled individually. Regulation within the barrel sections takes place by means of electrical heating and pneumatic cooling. The die element is heated by means of an oil thermostat. The rotational speed of the twin screws, which are fitted with conveying elements, is between 50 and 380 rpm.

The reaction product, obtained at a rate of from 10 to 130 kg/h, was cooled, comminuted, and bagged. It possesses a melting range of 89 to 92° C. and had an NCO content of 11.4%.

German application 10347902.3 filed on Oct. 15, 2003 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A solid polyaddition compound having one or more uretdione groups and comprising reacted components of
A) from 40% to 90% by mass of at least one aliphatic, (cyclo)aliphatic or cycloaliphatic polyisocyanate component comprising reacted units of
1. at least 40% by mass of a polyisocyanate compound containing one or more uretdione groups and having an average functionality of at least 2.0, and
2. not more than 60% by mass of at least one of a diisocyanate compound or an isocyanurate compound without uretdione groups;
B) from 60% to 10% by mass of dodecane-1,12-diol; and
C) from 50% to 0% by mass of at least one further compound having at least one hydroxyl group;
wherein the polyaddition compound has a melting point of from 40 to 130° C., a free NCO content of less than 5% by weight, and a uretdione content of from 6 to 18% by weight.

2. The solid polyaddition compound claimed in claim 1, wherein the polyisocyanate component A) comprises reacted units of at least one of an aliphatic, cycloaliphatic, araliphatic or aromatic diisocyanate.

3. The solid polyaddition compound claimed in claim 2, wherein the polyisocyanate component A) comprises reacted units of at least one of 1,6-diisocyanatohexane; 2-methylpentamethylene 1,5-diisocyanate; 2,2,4(2,4,4)-trimethylhexamethylene diisocyanate; 4,4′-diisocyanatodicyclohexylmethane; 1,3-diisocyanatocyclohexane; 4-diisocyanatocyclohexane; isophorone diisocyanate; diphenylmethane 2,4′-diisocyanate; diphenylmethane 4,4′-diisocyanate; xylylene diisocyanate; 2,4-tolylene diisocyanate; or 2,6-tolylene diisocyanate.

4. The solid polyaddition compound claimed in claim 1, wherein the polyisocyanate component A) comprises reacted units of at least one of IPDI or HDI.

5. The solid polyaddition compound claimed in claim 1, comprising reacted units of at least one of a monool, a diol or a polyol having a molecular weight of at least 32.

6. The solid polyaddition compound claimed in claim 1, comprising reacted units of at least one of methanol, ethanol, n-propanol, isopropanol, n-butanol, isobutanol, sec-butanol, an isomeric pentanol, an isomeric hexanol, an isomeric octanol, an isomeric nonanol, n-decanol, n-dodecanol, n-tetradecanol, n-hexadecanol, n-octadecanol, cyclohexanol, an isomeric methylcyclohexanol, hydroxymethylcyclohexane, ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol, neopentyl glycol hydroxypivalate, trimethylolpropane, ditrimethylolpropane, trimethylolethane, hexane-1,2,6-triol, butane-1,2,4-triol, tris(β-hydroxyethyl)isocyanurate, pentaerythritol, mannitol, sorbitol, a hydroxyl-containing polyester, a polycarbonate, a polycaprolactone, a polyether, a polythioether, a polyesteramide, a polyurethane or a polyacetal.

7. The solid polyaddition compound claimed in claim 1, obtained by reacting component A) and B), optionally in the presence of component C).

8. A process for preparing a solid polyaddition compound having one or more uretdione groups comprising:
reacting in a solvent at from 50 to 100° C.
A) from 40% to 90% by mass of at least one aliphatic, (cyclo)aliphatic or cycloaliphatic polyisocyanate component comprising reacted units of
1. at least 40% by mass of a polyisocyanate compound containing one or more uretdione groups and having an average functionality of at least 2.0, and
2. not more than 60% by mass of at least one of a diisocyanate compound or a isocyanurate compound without uretdione groups;
B) from 60% to 10% by mass of dodecane-1,12-diol;
C) from 50% to 0% by mass of at least one further compound having at least one hydroxyl group;
wherein the polyaddition compound has a melting point of from 40 to 130° C., a free NCO content of less than 5% by weight, and a uretdione content of from 6 to 18% by weight.

9. The process as claimed in claim 8, wherein the reacting is carried out in the presence of one or more of a catalyst or an adjuvant.

10. The process as claimed in claim 9, further comprising:
supplying the components, the adjuvant or the catalyst together or in separate product streams, in liquid or solid form, to an extruder, an intensive kneading apparatus, an intensive mixer or static mixer.

11. The process as claimed in claim 11, further comprising:
combining one or more adjuvants with the components to form one product stream.

12. The process as claimed in claim 11, wherein at least two product streams are supplied in bundled form.

13. A process for preparing a solid polyaddition compound having one or more uretdione groups comprising:
reacting in an intensive kneading apparatus at from 110 to 190° C.
A) from 40% to 90% by mass of at least one aliphatic, (cyclo)aliphatic or cycloaliphatic polyisocyanate component comprising reacted units of
1. at least 40% by mass of at least one of polyisocyanate compound containing one or more uretdione groups and having an average functionality of at least 2.0, and
2. not more than 60% by mass of at least one of a diisocyanate compound or a isocyanurate compound without uretdione groups;
B) from 60% to 10% by mass of dodecane-1,12-diol;
C) from 50% to 0% by mass of at least one further compound having at least one hydroxyl group;
wherein the polyaddition compound has a melting point of from 40 to 130° C., a free NCO content of less than 5% by weight, and a uretdione content of from 6 to 18% by weight.

14. The process as claimed in claim 13, wherein the reacting is carried out in a twin-screw extruder.

15. The process as claimed in claim 13, wherein the reacting is carried out in a single-screw extruder, twin-screw extruder, multi-screw extruder, annular extruder, or planetary roll extruder.

16. The process as claimed in claim 13, wherein the reacting is carried out in the presence of one or more of a catalyst or an adjuvant.

17. The process as claimed in claim 13, further comprising
supplying the components, the adjuvant or the catalyst together or in separate product streams, in liquid or solid form, to an extruder, an intensive kneading apparatus, an intensive mixer or a static mixer.

18. The process as claimed in claim 13, further comprising
combining one or more of the adjuvants with one or more of the components to form one product stream.

19. The process as claimed in claim 13, wherein at least two product streams are supplied in bundled form.
